(19) United States
(12) Patent Application Publication
(10) Pub. No.: US 2015/0275942 A1
(43) Pub. Date: Oct. 1, 2015

(54) Adapter For Flush Mount Receptacle Bases

(71) Applicant: JEFFREY D. CARNEVALI, Seattle, WA (US)

(72) Inventor: JEFFREY D. CARNEVALI, Seattle, WA (US)

(21) Appl. No.: 14/230,727

(22) Filed: Mar. 31, 2014

(51) Int. Cl. F16B 2/10; F16B 2/06

(52) U.S. Cl. CPC F16B 2/10; F16B 2/065

(57) ABSTRACT

An adapter for mounting a mounting structure on a flush mount receptacle base. The adapter includes a mounting base and an anchor. The mounting base is formed with a rigid base having a mounting structure extended therefrom, and a threaded bore formed therein and communicating with a contact surface of the rigid base.

The anchor is a shaft of a spring material that is threaded to mate with the threaded bore of the mounting base, and a clamp is formed adjacent to one end of the shaft. The clamp has a hook and an opposing closing gate. The shaft is split lengthwise between the hook and closing gate and through at least a portion of the threads, so the hook and closing gate are positioned on opposite legs of the split shaft. The legs of the split shaft are compressibly spread apart along the split.

### FIELD OF THE INVENTION

The present invention relates to an adapter for flush mount receptacle bases, and in particular to an adapter for securing a mounting base to a flush mount receptacle base.

### BACKGROUND OF THE INVENTION

Flush mount receptacle bases are generally well-known for temporary mounting of accessories on object surfaces. Such receptacle bases are known for mounting flush with the object's mounting surface so as to not present a raised surface when not in use. Flush mount receptacle bases are in general use on air and water craft, and may be utilized wherever flush mounting is desirable to avoid obstacles intruding on the surface when the mount is not in use.

One example of flush mount receptacle bases is the so-called leash plug that is anchored in a surfboard, a stand-up paddle boards, and similar craft, whereby the operator is able to attach a security leash, which is a line of extruded polyurethane bearing a loop on its distal end for a surfer or paddle boarder to retain about his ankle. Thus, an ankle leash may be secured and extended from the upper surface of the surfboard. When the operator is thrown off his surfboard, the leash retains the surfboard. The leash plug is formed as a cup with a cross-bar that is set into the top major surface of the surfboard blank. However, the security leash of the prior art is limited to another loop of woven material on its proximal end for securing to the leash plug.

### SUMMARY OF THE INVENTION

The present invention is a present invention is an adapter for mounting a mounting structure on a flush mount receptacle base. The adapter includes a mounting base and an anchor. The mounting base is formed with a rigid base having a mounting structure extended therefrom, and a threaded bore formed therein and communicating with a contact surface of the rigid base.

The anchor is formed of a shaft of a spring material, such as a stainless steel spring material. The shaft is threaded to mate with the threaded bore of the mounting base, and a clamp is formed adjacent to one end of the shaft. The clamp has at least one hook and an opposing closing gate. The shaft is split lengthwise between the hook and closing gate of the clamp and through at least a portion of the threads, so the hook and closing gate are positioned on opposite legs of the split shaft. The legs of the split shaft are compressibly spread apart along the split.

According to one aspect of the invention the closing gate of the clamp is another hook.

According to another aspect of the invention, the mounting structure is a ball mounting base.

According to another aspect of the invention, the shaft is threaded along substantially an entire length thereof.

According to another aspect of the invention, a method for attaching a mounting base to a flush mount receptacle base is provided. The method of the invention includes forming a mounting base and a cooperating anchor. Forming a mounting base includes forming a rigid base having a mounting structure extended therefrom, and optionally forming a threaded bore in the base.

Forming an anchor includes forming a shaft of a spring material, splitting the shaft lengthwise from one end thereof and through at least a portion of its length, forming a clamp adjacent to the one split end of the shaft at least one hook is positioned on a first leg of the split shaft and a closing gate is positioned on a second leg of the split shaft on an opposite side of the split therefrom. The shaft legs are compressibly spread apart along the split.

When the mounting base is optionally formed with a threaded bore, the cooperating anchor shaft is threaded to mate with the threaded bore of the mounting base.

The anchor shaft is partially received into the mounting base with the split and the clamp extended from the mounting base. When the mounting base and anchor shaft are threaded, partially receiving the anchor shaft into the mounting base is accomplished by partially threading the anchor into the threaded bore of the mounting base with the clamp and the split extended from the mounting base.

The mounting base is positioned adjacent to a flush mount receptacle base with the clamp of the anchor adjacent to a cross-bar in a cup of the receptacle base.

The mounting base is moved toward the receptacle base until the hook and the closing gate of the clamp are positioned adjacent to opposite sides of the cross-bar.

The anchor shaft is drawn in an advancing direction for advancing the anchor shaft into the mounting base for compressing the spread-apart shaft legs along the split, and drawing the anchor shaft in the advancing direction continues until the hook and the closing gate are compressed together on opposite sides of the cross-bar of the receptacle base and the rigid base contacts the receptacle base.

When the mounting base and anchor shaft are threaded, drawing the anchor shaft in the advancing direction into the mounting base for compressing the spread-apart shaft legs along the split, includes turning the mounting base relative to the receptacle base in a thread advancing direction for advancing the threads of the threaded bore along the threads of the anchor shaft for compressing the spread-apart shaft legs along the split, and continuing turning of the mounting base in the advancing direction until the hook and the closing gate are compressed together on opposite sides of the cross-bar of the receptacle base and the rigid base contacts the receptacle base.

According to another aspect of the invention, the method for attaching a mounting base to a flush mount receptacle base includes retreating the mounting base along the anchor shaft in a retreating direction opposite of the advancing direction for decompressing the shaft legs along the split, and retreating the mounting base in the retreating direction continues until the hook and the closing gate are expanded apart on opposite sides of the cross-bar of the receptacle base and the rigid base separates from the receptacle base.

When the mounting base and anchor shaft are threaded, retreating the mounting base along the anchor shaft includes turning the mounting base relative to the receptacle base in a thread retreating direction opposite of the thread advancing direction for retreating the threads of the threaded bore along the threads of the anchor shaft for decompressing the shaft legs along the split, and turning of the mounting base in the thread retreating direction continues until the hook and the closing gate are expanded apart on opposite sides of the cross-bar of the receptacle base and the rigid base separates from the receptacle base.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an example of a flush mount receptacle base of a type that is useful with the invention;

FIG. 2 illustrates one example of such a flush mount receptacle base being anchored in a target surface;

FIG. 3 illustrates the invention embodied by example and without limitation as an adapter for flush mount receptacle bases generally of the type illustrated in FIG. 1;

FIG. 4 is an exploded view of the adapter of the invention illustrated in FIG. 3;

FIG. 5 illustrates the adapter of the invention illustrated in FIG. 3 at the beginning of installation into a flush mount receptacle base;

FIG. 6 illustrates the adapter of the invention illustrated in FIG. 3 during installation into a flush mount receptacle base;

FIG. 7 illustrates a clamp of the adapter of the invention illustrated in FIG. 3 fitted over a cross-bar of the flush mount receptacle base;

FIG. 8 illustrates closing of the clamp of the adapter of the invention illustrated in FIG. 3 about cross-bar of the flush mount receptacle base; and

FIG. 9 illustrates the adapter of the invention emplaced on flush mount receptacle base.

### DETAILED DESCRIPTION OF PREFERRED EMBODIMENT

As required, a detailed illustrative embodiment of the present protective enclosure is disclosed herein. However, techniques, systems and operating structures in accordance with the present protective enclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present protective enclosure. The following presents a detailed description of an illustrative embodiment (as well as some alternative embodiments) of the present protective enclosure.

In the Figures, like numerals indicate like elements.

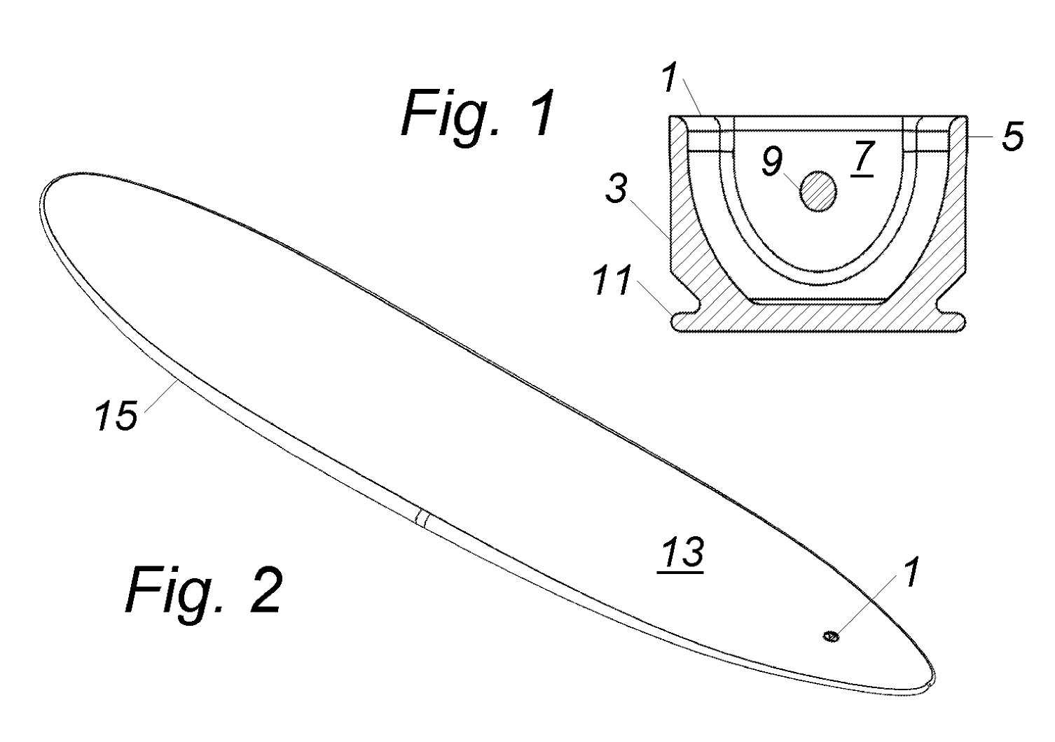

FIG. 1 illustrates an example of a flush mount receptacle base 1 of a type that is useful with the invention. Flush mount receptacle base 1 includes a cup portion 3 encircled at its top by an annular ridge 5 which may include a flange extension or rim (not shown) extending outwardly from annular ridge 5. An internal wall 7 of cup portion 3 depends downwardly from the top annular ridge 5. A cross-bar 9 crosses the top of the cup portion 3 and provides an attachment point for temporary mounting of accessories, such as a surfboard leash (not shown). Additionally, a flange 11 exterior of cup portion 3 is provided for anchoring receptacle base 1 in the surface 13 of a target substrate 15, such as a surfboard (shown), stand-up paddle boards, another similar craft, or other air or water craft. Alternatively, other anchoring means provided on cup portion 3 for anchoring receptacle base 1 include a flange extension or rim (not shown) extending outwardly from annular ridge 5 and adapted for being secured to the target surface with threaded fasteners; a threaded base formed exterior of cup portion 3; exterior of cup portion 3 being adapted to press-fit into the target surface; as well as other known means for securely anchoring such flush mount receptacle bases 1 in target surfaces.

FIG. 2 illustrates one example of such flush mount receptacle bases 1 being anchored in such a target surface 13. Here, flush mount receptacle bases 1 is anchored in a target surface 13 embodied by example and without limitation as the upper surface of a surfboard target substrate 15.

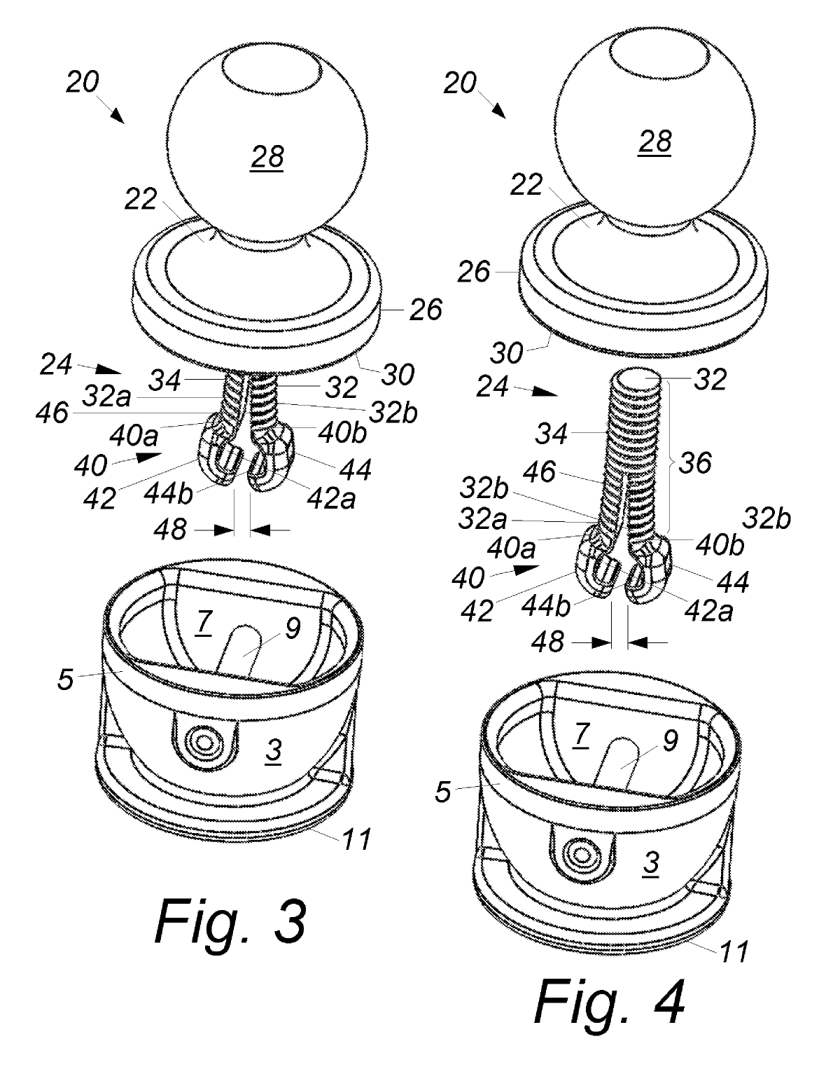

FIG. 3 illustrates the invention embodied by example and without limitation as an adapter 20 for flush mount receptacle bases 1.

Adapter 20 for flush mount receptacle bases 1 includes a mounting base 22 and an anchor 24. Mounting base 22 is formed with a rigid base 26 having a mounting structure 28 extended therefrom. Mounting structure 28 is illustrated here by example and without limitation as a ball mounting base. However, other structures are also known and are also contemplated for mounting structure 28 and may be substituted without deviating from the scope and intent of the present invention. As disclosed herein, mounting base 22 is formed with a threaded bore that extends through a contact surface 30 at rigid base 26.

Anchor 24 is formed as a shaft 32 of a spring material, for example a metal such as but not limited to a spring steel such as stainless steel. Shaft 32 is formed with male thread 34 along its length 36, with male thread 34 matched to the threaded bore in mounting base 22. A clamp 38 is provided adjacent to a clamp end 40 of anchor shaft 32, wherein clamp 38 has at least one hook 42 and a mating closing gate 44. Closing gate 44 is optionally but not limited to a second hook as shown. The mouth 42a of hook 42 and optionally of mouth 44a of closing gate hook 44 is either curved or an angled “V” shape, or another mouth shape structured grip cross-bar 9. Mouth 42a of hook 42 and mouth 44a, when present, of closing gate hook 44 may be about the same size as a diameter of cross-bar 9 in cup portion 3 of receptacle base 1. Alternatively, hook mouth 42a and closing gate hook mouth 44a, when present, is either larger or smaller than a diameter of cross-bar 9 of receptacle base 1 and remains effective for anchoring to cross-bar 9.

Hook 42 and closing gate 44 of clamp 38 are sprung open for ease of installing onto cross-bar 9 in cup portion 3 of receptacle base 1.

Anchor shaft 32 is formed with a lengthwise split 46 from clamp end 40 and extending lengthwise along anchor shaft 32 through at least a portion of male thread 34, whereby anchor shaft 32 is split into opposing legs 32a and 32b with hook 42 of clamp 38 on the split clamp end 40a of one shaft leg 32a, and closing gate 44 of clamp 38 on the opposing split clamp end 40b of the other shaft leg 32b. Legs 32a, 3b of anchor shaft 32 are compressibly spread apart along lengthwise split 46 such that hook 42 and closing gate 44 of clamp 38 are closably spread apart across a gap 48 sized to receive therebetween cross-bar 9 in cup portion 3 of receptacle base 1. Legs 32a, 32b are formed of the spring material of shaft 32 such that they are resilient and, though compressible together, they naturally return to their at-rest spread apart configuration when compression force is removed. Thus, hook 42 and closing gate 44 of clamp 38 and male thread 34 are compressibly spread apart along lengthwise split 46 of anchor shaft 32. As disclosed here, gap 48 between hook 42 and closing gate 44 of clamp 38 is optionally narrower, wider, or about the same as a diameter of cross-bar 9 in cup portion 3 of receptacle base 1 and remain effective for anchoring to cross-bar 9.

FIG. 4 is an exploded view of adapter 20 that more clearly illustrates anchor shaft 32 being formed with lengthwise split 46 from clamp end 40 through at least a portion of male thread 34. Thus, anchor shaft 32 is split into opposing legs 32a and 32b with hook 42 of clamp 38 on the split clamp end 40a of one shaft leg 32a, and closing gate 44 of clamp 38 on the opposing split clamp end 40b of the other shaft leg 32b.

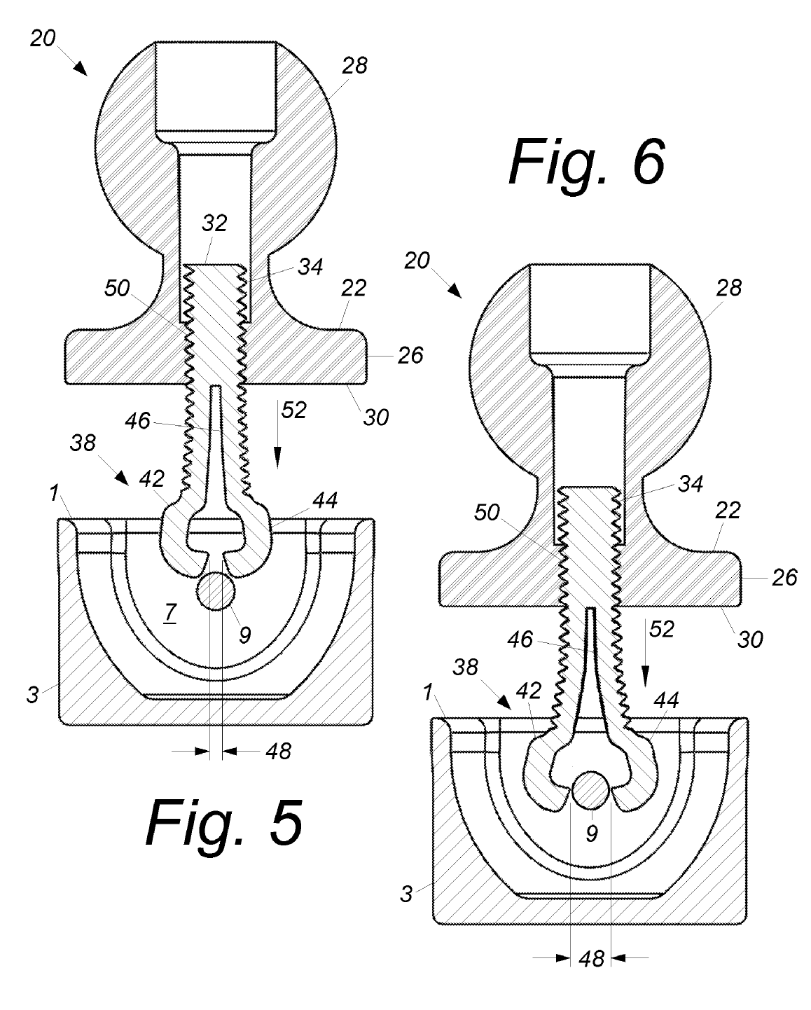

FIG. 5 illustrates adapter 20 at the beginning of installation into receptacle base 1. Adapter 20 is shown having anchor 24 inserted into mounting base 22 with male thread 34 on anchor shaft 32 threaded into a mating female threaded bore 50 in mounting base 22 through contact surface 30 at rigid base 26 thereof. During installation into receptacle base 1, anchor 24 of adapter 20 is brought to receptacle base 1, and clamp 38 is positioned adjacent to cross-bar 9 in cup portion 3. When gap 48 between hook 42 and closing gate 44 is the same or larger than the diameter of cross-bar 9 (FIG. 6), clamp 38 is simply slipped over cross-bar 9. Else, if gap 48 is smaller than the diameter of cross-bar 9, as shown, anchor 24 is pressed into interference contact with cross-bar 9. As a result of pressure (arrow 52) applied along anchor shaft 32, hook 42 and closing gate 44 clamp 38 are spread apart over cross-bar 9, thus opening gap 48 therebetween and spreading opposing legs 32a, 32b of anchor shaft 32 along lengthwise split 46. The spring material of anchor shaft 32 allows lengthwise split 46 to spread, and gap 48 to open sufficiently to receive cross-bar 9 between hook 42 and closing gate 44 of clamp 38.

FIG. 6 illustrates adapter 20 during installation into receptacle base 1. As a result of pressure (arrow 52) applied along anchor shaft 32, hook 42 and closing gate 44 clamp 38 are spread apart over cross-bar 9, thus gap 48 therebetween is opened and opposing legs 32a, 32b of anchor shaft 32 are spread along lengthwise split 46. The spring material of anchor shaft 32 allows lengthwise split 46 to spread, and gap 48 to be open sufficiently to receive cross-bar 9 between hook 42 and closing gate 44 of clamp 38.

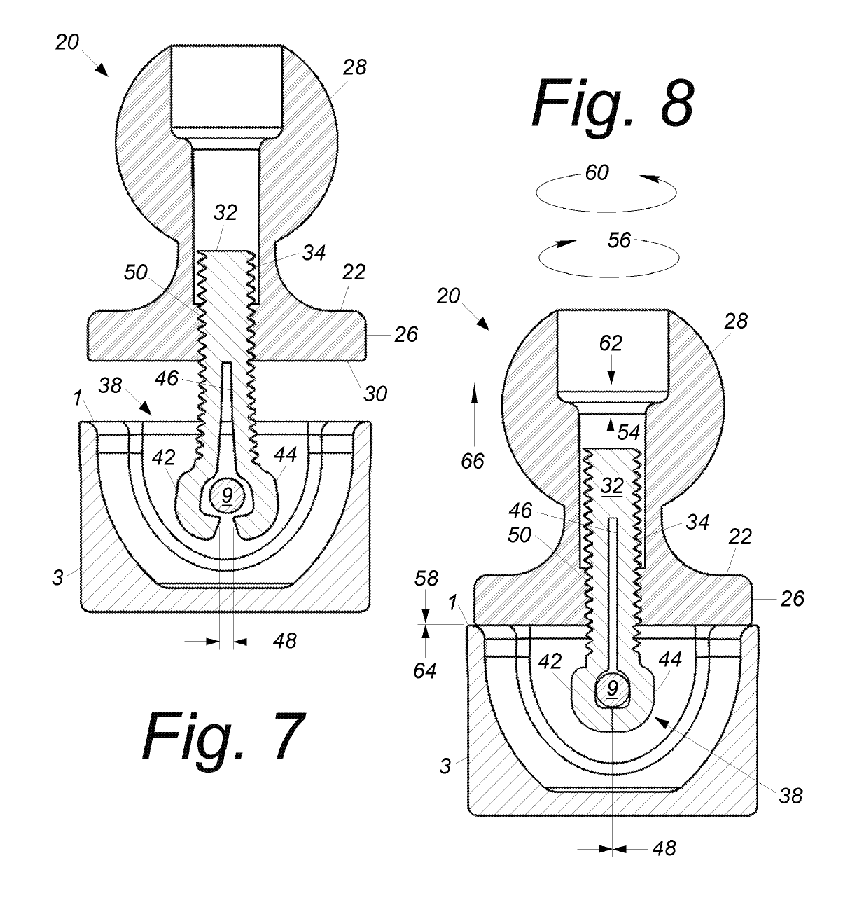

FIG. 7 illustrates clamp 38 fitted over cross-bar 9. When legs 32a, 3b of anchor shaft 32 are compressibly spread apart along lengthwise split 46 to admit cross-bar 9 through gap 48 between hook 42 and closing gate 44 of clamp 38, then gap 48 is resiliently narrowed to its natural at-rest state, whereby hook 42 and closing gate 44 of clamp 38 partially close around cross-bar 9.

FIG. 8 illustrates closing of closing gate 44 with hook 42 of clamp 38. Here, anchor shaft 32 is drawn (arrow 54) into mounting base 22 of adapter 20 by a puller mechanism embodied by example and without limitation as mating male threads 34 on anchor shaft 32 and female threaded bore 50. Thus, anchor shaft 32 is drawn (arrow 54) into mounting base 22 of adapter 20 by turning base 26 relative to receptacle base 1 in an advancing direction (arrow 56—clockwise shown by example and without limitation), whereby mating female threads 50 advance along male shaft threads 34. As anchor shaft 32 is drawn (arrow 54) into mounting base 22 of adapter 20 by turning base 26 in advancing direction (arrow 56), lengthwise split 46 is compressed to enter into threaded bore 50 of base 26. Accordingly, hook 42 and closing gate 44 are compressed together on opposite sides of cross-bar 9 of receptacle base 1, and gap 48 between hook 42 and closing gate 44 is closed, whereby cross-bar 9 is captured in clamp 38. Continued advancing (arrow 56) of base 26 continues to draw (arrow 54) anchor shaft 32 into mounting base 22 until contact surface 30 at rigid base 26 contacts receptacle base 1, whereupon mounting base 22 is securely anchored to receptacle base 1 with its mounting structure 28 extended above target surface 13.

Adapter 20 is unsecured and removed from receptacle base 1 in reverse order. When mounting base 22 is turned in a retreating direction (arrow 60) opposite of the advancing direction (arrow 56), interacting male threads 34 and female threaded bore 50 push anchor shaft 32 to retreat (arrow 62) from engagement with female threaded bore 50 in rigid base 26. As anchor shaft 32 exits rigid base 26, compression on lengthwise split 46 is released, and split 46 is permitted to expand or spread. Spreading or expanding apart of split 46 in turn permits gap 48 between hook 42 and closing gate 44 to open, which releases cross-bar 9 to pass therebetween. After gap 48 is sufficiently enlarged, adapter 20 is simply lifted away (arrow 64) from receptacle base 1. When natural at-rest state of gap 48 is narrower than diameter of cross-bar 9, as shown, a slight pulling force (arrow 66) exerted on mounting base 22 serves to force gap 48 sufficiently wide to release cross-bar 9 from between hook 42 and closing gate 44 of clamp 38, and adapter 20 is lifted away (arrow 64) from receptacle base 1.

In an alternative embodiment, a reversible cam mechanism is coupled between anchor shaft 32 and mounting base 22 for pulling anchor shaft 32 in the advancing direction (arrow 56) along bore 50. In such alternative embodiment, anchor shaft 32 and bore 50 are both smooth for ease of movement, although a key mechanism may be provided therebetween to retain relative angular orientation.

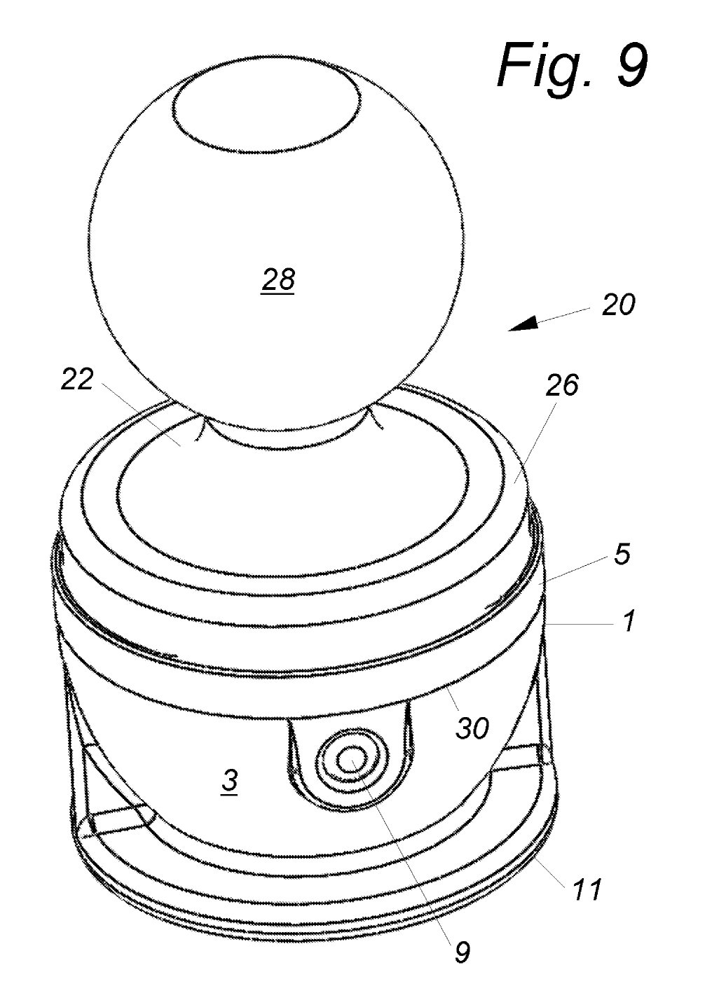

FIG. 9 illustrates adapter 20 emplaced on flush mount receptacle base 1.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. An adapter for a flush mount receptacle base, comprising:
a mounting base, comprising a rigid base having a mounting structure extended therefrom, and a threaded bore formed therein; and
an anchor, comprising:
a shaft of a spring material, the shaft being threaded to mate with the threaded bore of the mounting base, and
a clamp adjacent to one end of the shaft, the clamp comprising at least one hook and a closing gate, and
wherein the shaft is split lengthwise between the hook and closing gate of the clamp and through at least a portion of the threads, and being compressibly spread apart along the split.

2. The adapter of claim 1, wherein the closing gate of the clamp further comprises a hook.

3. The adapter of claim 1, wherein the mounting structure further comprises a ball mounting base.

4. The adapter of claim 1, wherein the rigid base of the mounting base further comprises a contact surface having the threaded bore formed therein.

5. The adapter of claim 1, wherein the shaft is threaded along substantially an entire length thereof.

6. The adapter of claim 1, wherein the spring material of the shaft is a metal.

7. The adapter of claim 6, wherein the metal spring material of the shaft is a stainless steel.

8. An adapter for a flush mount receptacle base, comprising:
a mounting base, comprising a rigid base having a mounting structure extended therefrom, and a receiver bore formed in a contact surface thereof;
an anchor cooperating with the mounting base, the anchor comprising:
a shaft formed of a spring material, the shaft being adapted to mate with the receiver bore of the mounting base,
a clamp adjacent to one end of the shaft, the clamp comprising at least one hook and a mating closing gate, and
a split formed lengthwise of the shaft opening between the hook and closing gate of the clamp and extending through at least a portion of the shaft, and being compressibly spread apart along the split; and
a reversible puller operable between the anchor shaft and the receiver bore of the mounting base.

9. The adapter of claim 8, wherein the closing gate of the clamp further comprises a hook.

10. The adapter of claim 8, wherein the mounting structure further comprises a ball mounting base.

11. The adapter of claim 8, wherein the reversible puller is further adapted for reversibly drawing the anchor shaft into the receiver bore of the mounting base.

12. The adapter of claim 11, wherein the reversible puller further comprises male screw threads formed along at least a portion of a length of the anchor shaft, and a mating female screw threads formed along at least a portion of a length of the receiver bore.

13. The adapter of claim 8, wherein the spring material of the shaft is a stainless steel.

14. A method for attaching a mounting base to a flush mount receptacle base, comprising:
forming a mounting base with a rigid base having a mounting structure extended therefrom, and forming a threaded bore in the base;
forming an anchor having a shaft of a spring material, the forming of the anchor comprising: threading the shaft to mate with the threaded bore of the mounting base, splitting the shaft lengthwise from one end thereof and through at least a portion of the threads, forming a clamp adjacent to the one split end of the shaft, wherein the forming of the clamp comprises positioning at least one hook on a first leg of the split shaft and positioning a closing gate on a second leg of the split shaft on an opposite side of the split therefrom, and compressibly spreading apart the shaft legs along the split;
partially threading the anchor into the threaded bore of the mounting base with the clamp and the split extended from the mounting base;
positioning the mounting base adjacent to a flush mount receptacle base with the clamp of the anchor adjacent to a cross-bar in a cup of the receptacle base;
moving the mounting base toward the receptacle base until the hook and the closing gate of the clamp are positioned adjacent to opposite sides of the cross-bar;
turning the mounting base relative to the receptacle base in an advancing direction for advancing the threads of the threaded bore along the threads of the anchor shaft for compressing the spread-apart shaft legs along the split, and continuing turning of the mounting base in the advancing direction until the hook and the closing gate are compressed together on opposite sides of the cross-bar of the receptacle base and the rigid base contacts the receptacle base.

15. The method of claim 14, wherein the flush mount receptacle base is a leash plug.

16. The method of claim 14, further comprising turning the mounting base relative to the receptacle base in a retreating direction opposite of the advancing direction for retreating the threads of the threaded bore along the threads of the anchor shaft for decompressing the shaft legs along the split, and continuing turning of the mounting base in the retreating direction until the hook and the closing gate are expanded apart on opposite sides of the cross-bar of the receptacle base and the rigid base separates from the receptacle base.

17. A method for attaching a mounting base to a flush mount receptacle base, comprising:
forming a mounting base with a rigid base having a mounting structure extended therefrom;
forming a cooperating anchor having a shaft of a spring material, the forming of the anchor comprising: splitting the shaft lengthwise from one end thereof and through at least a portion of a length thereof, forming a clamp adjacent to the one split end of the shaft, wherein the forming of the clamp comprises positioning at least one hook on a first leg of the split shaft and positioning a closing gate on a second leg of the split shaft with the split therebetween, and compressibly spreading apart the shaft legs along the split;
partially receiving the anchor shaft into the mounting base with the split and the clamp extended from the mounting base;
positioning the mounting base adjacent to a flush mount receptacle base with the clamp of the anchor adjacent to a cross-bar in a cup of the receptacle base;
moving the mounting base toward the receptacle base until the hook and the closing gate of the clamp are positioned adjacent to opposite sides of the cross-bar;
drawing the anchor shaft in an advancing direction for advancing the anchor shaft into the mounting base for compressing the spread-apart shaft legs along the split, and continuing drawing the anchor shaft in the advancing direction until the hook and the closing gate are compressed together on opposite sides of the cross-bar of the receptacle base and the rigid base contacts the receptacle base.

18. The method of claim 17, further comprising retreating the mounting base along the anchor shaft in a retreating direction opposite of the advancing direction for decompressing the shaft legs along the split, and continuing retreating the mounting base in the retreating direction until the hook and the closing gate are expanded apart on opposite sides of the cross-bar of the receptacle base and the rigid base separates from the receptacle base.

19. The method of claim 17, wherein forming a mounting base further comprises forming bore with a female thread in the mounting base that communicates with a contact surface of the rigid base;
forming an anchor further comprises threading the shaft with a male thread to mate with the female thread in the bore of the mounting base;
partially receiving the anchor shaft into the mounting base further comprises partially threading the male thread of the shaft into the female thread of the bore; and
drawing the anchor shaft in an advancing direction for advancing the anchor shaft into the mounting base further comprises turning the female threads of the bore in an advancing direction along the male threads of the shaft.

20. The method of claim 19, further comprising turning the mounting base relative to the receptacle base in a retreating direction opposite of the advancing direction for retreating the threads of the threaded bore along the threads of the anchor shaft for decompressing the shaft legs along the split, and continuing turning of the mounting base in the retreating direction until the hook and the closing gate are expanded apart on opposite sides of the cross-bar of the receptacle base and the rigid base separates from the receptacle base.
